(19) United States
(12) Patent Application Publication
(10) Pub. No.: US 2019/0212960 A1
(43) Pub. Date: Jul. 11, 2019

(54) PRINT MEDIUM PROCESSING

(71) Applicant: Hewlett-Packard Development Company, L.P., Spring, TX (US)

(72) Inventors: Robert Yraceburu, Vancouver, WA (US); Dawn M Beachnau Hood, Vancouver, WA (US); Brooke Hoyer, Vancouver, WA (US); Milan Crowley Justel, Vancouver, WA (US)

(21) Appl. No.: 16/331,571

(22) PCT Filed: Sep. 9, 2016
(86) PCT No.: PCT/US2016/051022

§ 371 Date: Mar. 8, 2019

(51) Int. Cl. G06F 3/12

(52) U.S. Cl. CPC G06F 3/1253; G06F 3/1297; G06F 3/1282; G06F 3/1221

(57) ABSTRACT

Example implementations relate to print medium processing. For example, a non-transitory computer readable medium may store instructions executable by a processing resource to determine an attribute of a print medium and adjust a print processing parameter based on the attribute of the print medium. The non-transitory computer readable medium may further store instructions executable by the processing resource to process, with a page processing mechanism, the print medium based on the print processing parameter.

### BACKGROUND

Print media can be processed to, for example, remove moisture therefrom. Processing print media that include different amounts of moisture can consume different amounts of energy and/or amounts of time, which can alter throughput of a printing device.

### BRIEF DESCRIPTION OF THE DRAWINGS

FIG. 1 illustrates a diagram of an example of a system for print medium processing consistent with the disclosure.

FIG. 2 illustrates a diagram of an example of a system for print medium processing including a controller and printing device consistent with the disclosure.

FIG. 3 illustrates a diagram of an example of a system for print medium processing including a host, controller, and printing device consistent with the disclosure.

FIG. 4 illustrates a flow diagram for an example method for print medium processing consistent with the disclosure.

FIG. 5 illustrates a diagram of an example of a non-transitory computer readable medium and processing resource for print medium processing consistent with the disclosure.

### DETAILED DESCRIPTION

A printing device may print input data onto a print medium such as paper. For example, a CMYK printing device may print input data with various amounts and/or concentrations of cyan (C), magenta (M), yellow (Y), and/or black (K) ink. The various amounts and/or concentrations of the different inks may be located in, distributed across, and/or dispersed across different regions of the print medium. Because each of the inks may have a different chemical composition and/or moisture content, the inks may exhibit different drying characteristics. As used herein, “moisture content” is the fluid content, such as an amount of carrier fluid, associated with a particular ink. In some examples, based on the chemical compositions and/or fluid makeups of the different inks, an ink of a particular color may dry slower or faster than an ink of a different color. In addition, ink that is concentrated more densely in particular regions of the print medium may dry at a different rate than ink that is concentrated less densely in particular regions of the print medium. Although described above in terms of a CMYK printer, the systems, methods, and computer readable media described herein may be operable with other types of printers, such as monochrome printers.

Print media can be processed to remove moisture therefrom. For example, a print medium can be processed to remove moisture associated with ink that has been added to the print medium as part of a printing process. Processing a print medium can involve heating the print medium, causing an air stream to come into contact with the print medium (e.g., applying a fan to the print medium), providing electromagnetic radiation at a particular frequency or frequencies to the print medium, and/or evaporatively cooling the print medium, as well as other techniques that can allow the moisture to be removed from the print medium. As used herein, a “print medium” or “print media” are media that a printing device can print data onto, for example, paper, transparencies, and newsprint, among other examples.

Processing print media may alter an amount of time that a print job may consume different amounts of energy depending on the moisture associated with print medium. For example, in the case of a print medium that has varying amounts of moisture distributed and/or dispersed across its surface, some portions of the print medium may be processed differently than other portions of the same page. This can cause page distortion, for example, waviness, cockle, and/or curl in regions of the print medium that include more moisture than other regions of the print medium, and/or in regions of the print medium in which the concentration of moisture is more dense than other regions of the print medium. As used herein, “cockle” refers to localized page distortion that can lead to wrinkling of a print medium in regions of the print medium with a high moisture content, while “curl” refers to the curving of a print medium due to excessive heat and/or moisture being applied to the print medium. Due to different amounts and/or concentrations of moisture that may be distributed across the print medium, print medium may be processed in different ways, at different energy consumption rates, and/or for different amounts of time, all of which may alter an amount of time before the print medium is dry and ready for use.

In some approaches, a printing device include one or more page processing mechanisms that may be used to process by evaporating the fluid content of the ink on the print medium such that the ink attaches to the print medium, for example. A printing device may include one or more page processing mechanisms that may be used to process the print media. Examples of page processing mechanisms include drying mechanisms such as heaters and/or fans. In some approaches, the print medium may be processed using the page processing mechanism(s), which may operate at a fixed temperature, energy consumption, wavelength, and/or fan speed. By processing print media using a page processing mechanism that operates at a fixed temperature, energy consumption, wavelength, and/or fan speed, the print medium may be subjected to cockling and/or curling, especially in regions of the print medium that include different amounts of moisture. As used herein, a “page processing mechanism” is a mechanism that is configured to process print media to, for example, remove moisture from the print medium thereby drying ink that has been applied to the print medium. Non-limiting examples of page processing mechanisms include one or more heaters, fans, film heaters, infrared heaters, etc.

In some approaches, processing print media at a fixed temperature, energy consumption, wavelength, and/or fan speed may result in unnecessary consumption of energy, because the different inks may exhibit different drying characteristics based on their chemical compositions, fluid makeups, and/or their concentrations, locations, and/or dispersions on the print medium. In addition or alternatively, in some approaches, processing print media can alter a speed at which a printing device can complete printing and processing of the print media. For example, processing print media can alter the International Organization for Standardization (ISO) speed at which the printing device can complete printing and processing of the print media.

In contrast, examples herein may allow for dynamic adjustment of page processing mechanisms, which can reduce energy consumption associated with removing moisture from print media. In some examples, energy consumption may be reduced by operating a print processing mechanism in a reduced energy consumption state, or powering down the print processing mechanism, when it is not being used to remove moisture from the print medium. For example, maximum settings for a print processing mechanism may be used when a determination is made that a print medium has a higher risk level with respect to mechanical reliability and/or output quality as compared to a different print medium. In some examples, dynamically adjusting settings of a page processing mechanism may allow for removal of moisture from a print medium without over-drying the print medium, which may reduce cockling and/or curl of the print medium. As used herein, a “risk level” is an indication of how dense the moisture content of the print medium is in certain portions of the print medium. As used herein, a “dense moisture content” refers to a moisture content in certain portions of a print medium that is comparatively greater than a moisture content in other portions of the print medium.

In some examples, a print processing parameter may be assigned to the print medium based on the risk level of the print medium. For example, a print processing parameter may be assigned to the print medium based on the amount of moisture on the print medium, the concentration of the moisture in one or more portions of the page, a desired output quality of the print medium, a mechanical reliability associated with the printing device and/or the print processing mechanism(s), etc. The print processing parameter may be used to determine a speed at which the print medium is to be printed and/or processed, and/or settings of the print processing mechanism(s).

Examples of the present disclosure include methods, systems, and computer-readable media storing executable instructions for print medium processing. For example, methods, systems, and computer-readable media storing executable instructions that may allow for print medium processing by a printing device in a computer network are described herein. In some examples, a non-transitory computer readable medium may store instructions executable by a processing resource to determine at least one attribute of a print medium and adjust a print processing parameter based on the at least one attribute of the print medium. The medium may further store instructions executable by the processing resource to process, with a page processing mechanism, the print medium based on the print processing parameter. As used herein, an “attribute” of a print medium is a quality or feature of the print medium. Examples of attributes of a print medium include the feel or texture of the print medium, the amount of moisture applied to the print medium, the flatness of the print medium, and/or a desired output stack quality of the print medium, as well as other qualities and/or features of the print medium.

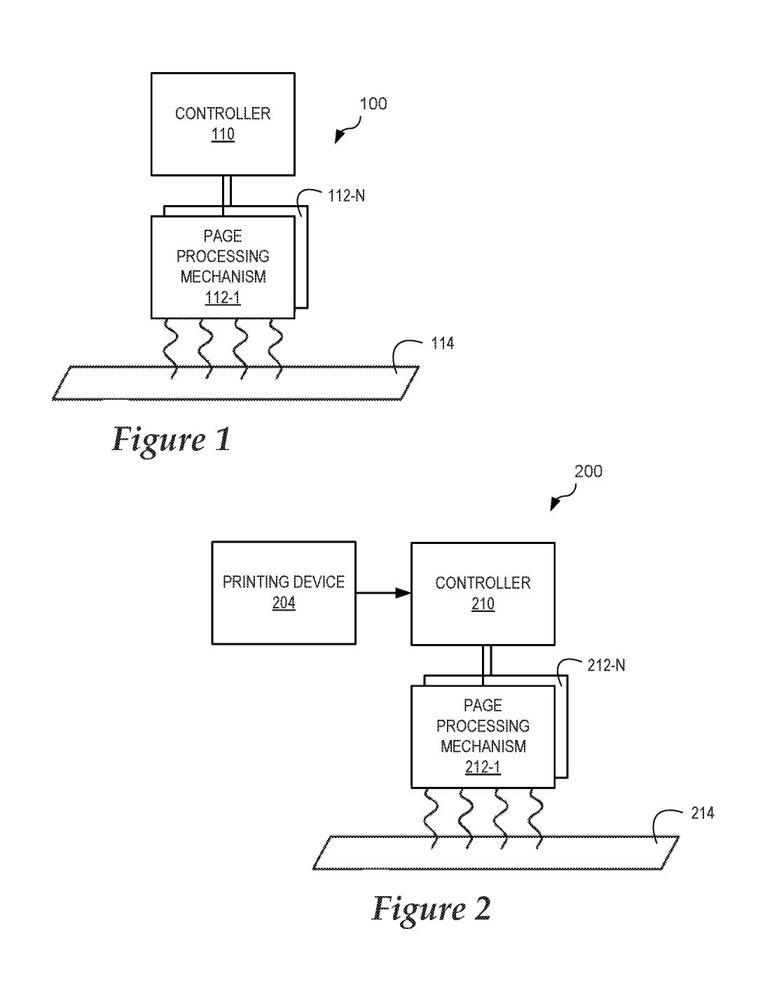

Turning now to the figures, FIG. 1 illustrates a diagram of an example of a system 100 for print medium processing consistent with the disclosure. The system 100 includes a controller 110 and one or more page processing mechanisms 112-1, . . . , 112-N, which may be referred to generally herein as “page processing mechanism(s) 112.” In some examples, the controller 110 can include hardware and/or instructions (e.g., microcode instructions) in the form of an application specific integrated circuit (ASIC). The controller 110 may execute instructions stored on a processing resource associated with the controller 110 and/or may execute instructions stored in memory coupled to the controller 110. For example, the controller 110 may execute instructions to determine at least one attribute of a print medium 114, adjust a print processing parameter based on the at least one attribute of the print medium 114, and/or cause the print medium 114 to be processed, based on the print processing parameter, with a page processing mechanism(s) 112.

As used herein, a “print processing parameter” is a parameter that may be used to determine a setting of a print processing mechanism. Non-limiting examples of print processing parameters include an amount of heat (e.g., a temperature, intensity, and/or duration heat is applied to the print medium) to be used while processing the print medium, an amount of air (e.g., a rate of air flow and/or a duration an air flow is applied to the print medium) caused to come into contact with the print medium while processing the print medium, an amount of electromagnetic radiation (e.g., an intensity, wavelength, frequency, and/or duration of application of the electromagnetic radiation) applied to the print medium, and/or an amount of time to evaporatively cool the print medium, as well as other parameters that can be altered to allow the moisture to be removed from the print medium.

The system 100 can operate with a variety of printing devices. For example, system 100 may be operated as part of a high-speed production printing device that is operable to print large volumes of information such as newspapers, enterprise payrolls, magazines, etc. In a high-speed production printing device, the print medium 114 may be a continuous form print medium. Examples are not so limited; however, and the system 100 may be operated as part of a small-scale printing system (e.g., personal home printing device) that is operable to print small volumes of information such as text documents, emails, photographs, etc. In a small-scale printing device, the print medium 114 may be individual pages (e.g., photocopier paper, resume paper, etc.), or photo paper, for example.

FIG. 2 illustrates a diagram of an example of a system 200 for print medium processing including a controller 210 and printing device 204 consistent with the disclosure. The system 200 includes a printing device 204 controller 210, and one or more page processing mechanisms 212. As shown in FIG. 2, page processing mechanism(s) 212 may be configured to process print medium 214. In some examples, the printing device 204 can be coupled to the page processing mechanism(s) 212 and/or the controller 210, and may print data on the print medium 214 prior to processing the print medium 214 with the page processing mechanism(s) 212.

The system 200 may be operable to process a print medium 214 using the page processing mechanism(s) 212 in response to instructions received from the controller 210. In some examples, the print medium 212 may include moisture as a result of the printing device 204 printing input data on to the print medium 214. As a result of the printing device 204 applying moisture to the print medium 214, the print medium 214 may have different concentrations of moisture in different regions of the print medium 214.

In some examples, the controller 210 may identify the regions of the print medium 214 that have different concentrations of moisture and adjust a print processing parameter based on the moisture concentration in one or more different regions of the print medium 214. Stated differently, in some examples, the controller 210 may adjust a print processing parameter based on one or more attributes of the print medium 214.

In some examples, the controller 210 may cause the print medium 214 to be processed, based on the print processing parameter, with one or more page processing mechanisms 212. For example, the controller 210 may cause the page processing mechanism(s) 212 to provide different amounts of heat to the print medium 214 and/or to provide heat to the print medium 214 for different amounts of time based on the attributes of the print medium 214. In some examples, the controller 210 may cause the processing mechanism(s) 212 to provide different amounts of air flow to the print medium 214 and/or to provide an air flow to the print medium 214 for different amounts of time based on the attributes of the print medium 214.

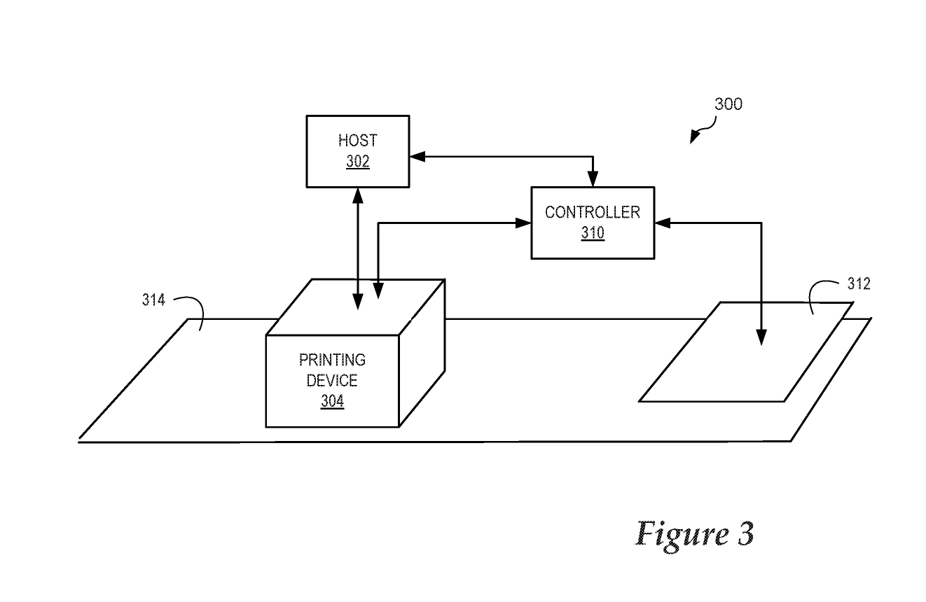

FIG. 3 illustrates a diagram of an example of a system 300 for print medium processing including a host 302, controller 310, and printing device 304 consistent with the disclosure. As shown in FIG. 3, the system 300 may include a page processing mechanism 312. So as to not obfuscate the drawing, a single page processing mechanism 312 is shown in FIG. 3; however, as will be appreciated, one or more page processing mechanisms 312 may be included in system 300, as illustrated in FIGS. 1 and 2, herein.

In some examples, the host 302 can be a host system and may include a system motherboard and/or backplane and can include a number of processing resources (e.g., one or more processors, microprocessors, or some other type of controlling circuitry). In some examples, the host 302 can be part of the printing device 304; however, examples are not so limited, and the host 302 can be separate from the printing device 304 so long as the host 302 and is in communication with the printing device 304 and/or the controller 310.

In some examples, the controller 310 may provide control signals to the page processing mechanism(s) 312 to cause the page processing mechanism(s) 312 to process the print medium 314. Control signals may include pulses and/or frequencies of electricity and/or light that represent a control command. For example, a control signal may be an electrical signal at a certain frequency or frequencies that represents a command to perform an operation or operations. For different print media 314 and/or as the print medium 314 is processed with the page processing mechanism(s) 312, an amount of processing the print medium 314 is subjected to may vary. In some examples, the controller 310 may be operable to provide temporal and/or spatial processing control of the page processing mechanism(s) 312 based on an attribute of the print medium 314 and/or a print processing parameter.

In some examples, the controller 310 may be operable to determine an attribute of a print medium (e.g., a second print medium) that is printed subsequent to print medium 314 (e.g., a first print medium). For example, the controller 310 may be operable to determine an attribute of a second print medium that is printed at a later point in time than the first print medium. The host 302 and/or the controller 310 may then adjust the print processing parameter based on the attribute of the second print medium. In some examples, the host 302 and/or controller 310 may cause the second print medium to be processed, based on a print processing parameter that is based on the attribute of the second print medium, with the page processing mechanism(s) 312. In some examples, the attribute of the second print medium may be different than the attribute of the first print medium.

Examples are not limited to the example systems shown in FIGS. 1-3, and the components of FIGS. 1-3 may be located in a single system or reside in separate distinct locations in a distributed network, cloud computing, enterprise service environment (e.g., Software as a Service (SaaS) environment), etc.

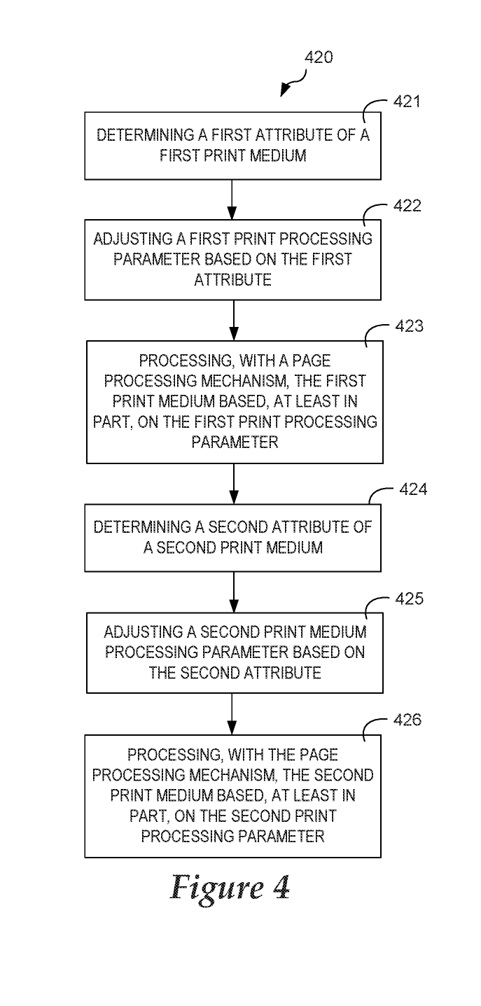

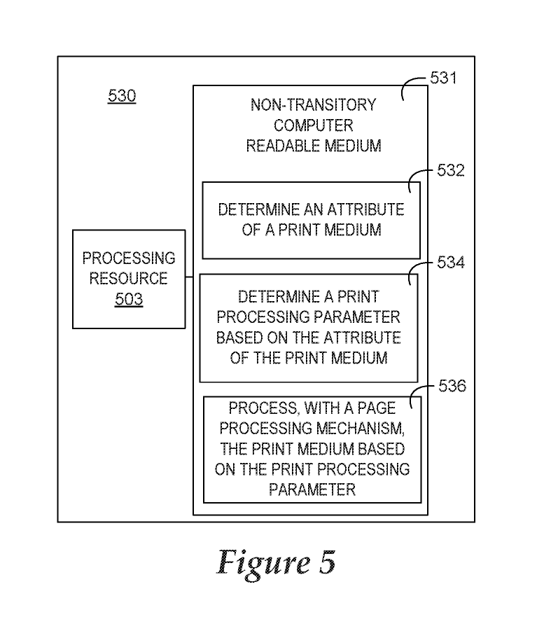

FIG. 4 illustrates a flow diagram for an example method for print medium processing consistent with the disclosure. In various examples, the method 420 may be performed using the systems 100, 200, and/or 300 shown in FIGS. 1-3 and/or the processing resource 503 and non-transitory computer readable medium 531 shown in FIG. 5. Examples are not, however, limited to these example systems, devices, processing resources and/or non-transitory computer readable media.

At 421, the method 420 can include determining a first attribute of a first print medium. For example, the method 420 can include determining a feel or texture of the first print medium, an amount of moisture applied to the first print medium, a flatness of the first print medium, and/or a desired output stack quality of the first print medium, as well as other qualities and/or features of the first print medium. As used herein, a “desired output stack quality” refers to a selectable parameter that relates to the quality of a printout produced by a printing device. Examples of a desired output stack quality include dots per inch (DPI) of the printout, ink quality/quality used in the printing device, type of print medium, among other examples.

At 422, the method 420 can include adjusting a first print processing parameter based on the first attribute. For example, an amount of time and/or type of processing that will be applied by the print processing mechanism(s) can be adjusted based on the first attribute.

At 423, the method 420 can include processing, with a page processing mechanism, the first print medium based, at least in part, on the first print processing parameter. In some examples, the first print medium can be processed at a specific heat, specific fan speed, and/or for a specific amount of time based on the print processing parameter.

At 424, the method 420 can include determining a second attribute of a second print medium. For example, the method 420 can include determining a feel or texture of the second print medium, an amount of moisture applied to the second print medium, a flatness of the second pint medium, and/or a desired output stack quality of the second print medium, as well as other qualities and/or features of the second print medium.

At 425, the method 420 can include adjusting a second print processing parameter based on the second attribute. For example, an amount of time and/or type of processing that will be applied by the print processing mechanism(s) can be adjusted based on the second attribute.

At 426, the method 420 can include processing, with the page processing mechanism, the second print medium based, at least in part, on the second print processing parameter. For example, the method 420 can include determining a feel or texture of the print medium, an amount of moisture applied to the print medium, a flatness of the print medium, and/or a desired output stack quality of the print medium, as well as other qualities and/or features of the print medium.

In some examples, the method 420 may include adjusting a first speed at which the first print medium is processed and adjusting a second speed at which the second print medium is processed. In some examples, the first speed and the second speed may be based, at least in part, on determining the first attribute and the second attribute.

FIG. 5 illustrates a diagram 530 of an example of a non-transitory computer readable medium 531 and processing resource 503 for printed page processing consistent with the disclosure. For example, the system 530 may be an implementation of the example systems of FIGS. 1-3 or the example method of FIG. 4.

The processing resource 503 may execute instructions stored on the non-transitory computer readable medium 531. The non-transitory computer readable medium 531 may be any type of volatile or non-volatile memory or storage, such as random access memory (RAM), flash memory, read-only memory (ROM), storage volumes, a hard disk, or a combination thereof.

The example medium 531 may store instructions 532 executable by the processing resource 503 to determine an attribute of a print medium. For example, the instructions 532 to determine a feel or texture of the print medium, an amount of moisture applied to the print medium, a flatness of the print medium, and/or a desired output stack quality of the print medium, as well as other qualities and/or features of the print medium

The example medium 531 may further store instructions 534. The instructions 534 may be executable to adjust a print processing parameter based on the at least one attribute of the print medium. For example, the instructions 534 may be executable to adjust an amount of time and/or type of processing that will be applied by the print processing mechanism(s) to the print medium based on the attribute.

The example medium 531 may further store instructions 536. The instructions 536 may be executable to process, with a page processing mechanism, the print medium based on the print processing parameter. In some examples, the instructions 536 may be executable to process the print medium at a specific heat, specific fan speed, and/or for a specific amount of time based on the print processing parameter.

In some examples, the example medium 531 may further store instructions that may be executable by the processing resource 503 to adjust the print processing parameter by adjusting a fan speed setting associated with the page processing mechanism. For example a speed setting associated with one or more fans provided as part of the print processing mechanism(s) can be adjusted. In some examples, the example medium 531 may further store instructions that may be executable by the processing resource 503 to adjust the print processing parameter by adjusting a temperature setting associated with the page processing mechanism. For example a temperature setting associated with one or heaters provided as part of the print processing mechanism(s) can be adjusted.

In some examples, the example medium 531 may further store instructions that may be executable by the processing resource 503 to determine a risk level associated with a second print medium to be processed with the page processing mechanism, adjust the print processing parameter based on the risk level, and process, with the page processing mechanism, the second print medium based on the adjusted print processing parameter. For example, the example medium 531 may store instructions that may be executable by the processing resource 503 to preemptively adjust the print processing parameter such that the page processing mechanism is ready to process a second print medium that is printed subsequent to the print medium based on a different print processing parameter than the first print medium was processed with.

By adjusting the print processing parameter for the second print medium before the second print medium is printed and/or processed, the second print medium may be processed based on the different print processing parameter with a reduced lag or wait time, because the page processing mechanism may already be setup for the different print processing parameter. In some examples, lag or wait times may vary from several seconds to several minutes; accordingly, reducing lag or wait times may result in increased throughput of a printing device.

As a non-limiting example, a risk level can be determined for a print medium that is to be processed at some point in time subsequent to another print medium. Based on the risk level of the print medium, it may be determined that the print medium that is to be processed at the point in time subsequent to the other print medium is to be processed based on a print processing parameter that is different than the other print medium. Once the determination is made, a setting associated with the page processing mechanism may be changed preemptively such that the page processing mechanism is operating based on the print processing parameter for the print medium that is to be processed at the subsequent point in time. For example, it may be determined that the print medium to be processed at the subsequent point in time may require more or less heat (or a higher or lower fan setting) than the other print medium. In some examples, the page processing mechanism may begin to adjust toward the heat (or fan) setting associated with the print processing parameter for the print medium to be processed at the subsequent point in time prior to this subsequent print medium being printed and/or processed.

This may allow for additional time for the page processing mechanism to, for example, gradually increase in temperature such that the temperature associated with the print processing mechanism is closer to a temperature that may result in more effective processing of the subsequent print medium than if the temperature associated with the page processing mechanism was not adjusted prior to the subsequent page being printed and/or processed. In some examples, this may allow for reduced wait times between processing print media with disparate attributes and/or may increase throughput of a printing device.

In some examples, the example medium 531 may further store instructions that may be executable by the processing resource to process the print medium with the page processing mechanism by drying the print medium using a one of a fan and/or a heat source. The example medium 531 may further store instructions that may be executable by the processing resource to determine the attribute of the print medium by determining a risk level associated with the print medium. In some examples, risk level may be based, at least in part, on a desired output quality of the print medium.

In some examples, the example medium 531 may further store instructions that may be executable by the processing resource to adjust an amount of time between processing the print medium and processing a second print medium printed subsequent to the print medium. For example, the instructions may be executable to adjust an amount of time between processing a first print medium and processing a second medium that is printed subsequent to the first print medium.

In the foregoing detailed description of the present disclosure, reference is made to the accompanying drawings that form a part hereof, and in which is shown by way of illustration how one or more examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. As used herein, designators such as “N”, etc., particularly with respect to reference numerals in the drawings, indicate that a number of the particular feature so designated can be included. As used herein, “a number of” a particular thing can refer to one or more of such things (e.g., a number of computing devices can refer to one or more computing devices). A “plurality of” is intended to refer to more than one of such things. Multiple like elements may be referenced herein generally by their reference numeral without a specific identifier at the end. For example, a plurality of print processing mechanisms 112-1, . . . , 112-N may be referred to herein generally as a plurality of print processing mechanisms 112.

The figures herein follow a numbering convention in which the first digit corresponds to the drawing figure number and the remaining digits identify an element or component in the drawing. For example, reference numeral 110 may refer to element “10” in FIG. 1 and an analogous element may be identified by reference numeral 210 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

As used herein, “logic” is an alternative or additional processing resource to perform a particular action and/or function, etc., described herein, which includes hardware, for example, various forms of transistor logic, application specific integrated circuits (ASICs), etc., as opposed to computer executable instructions, for example, software firmware, etc., stored in memory and executable by a processor.

What is claimed:

1. A non-transitory computer readable medium storing instructions executable by a processing resource to:
determine an attribute of a print medium;
determine a print processing parameter based on the attribute of the print medium; and
process, with a page processing mechanism, the print medium based on the print processing parameter.

2. The non-transitory computer readable medium of claim 1, wherein the instructions to adjust the print processing parameter include instructions executable by the processing resource to adjust a fan speed setting or a temperature setting associated with the page processing mechanism.

3. The non-transitory computer readable medium of claim 1, wherein the instructions are further executable to:
determine a risk level associated with a second print medium to be processed with the page processing mechanism;
based on the risk level, adjust the print processing parameter; and
process, with the page processing mechanism, the second print medium based on the adjusted print processing parameter.

4. The non-transitory computer readable medium of claim 1, wherein the instructions to process the print medium with the page processing mechanism include instructions executable by the processing resource to dry the print medium using a fan or a heat source.

5. The non-transitory computer readable medium of claim 1, wherein the instructions to determine the attribute of the print medium include instructions executable by the processing resource to determine a risk level associated with the print medium.

6. The non-transitory computer readable medium of claim 5, wherein the risk level is based, at least in part, on a desired output quality of the print medium.

7. The non-transitory computer readable medium of claim 1, wherein the instructions to adjust the print processing parameter include instructions executable by the processing resource to adjust an amount of time between processing the print medium and processing a second print medium printed subsequent to the print medium.

8. A system, comprising:
a page processing mechanism; and
a controller coupled to the page processing mechanism, the controller to:
determine an attribute of a print medium;
adjust a print processing parameter based on the attribute of the print medium; and
cause the print medium to be processed, based on the print processing parameter, by the page processing mechanism.

9. The system of claim 8, further comprising a printing device coupled to the page processing mechanism and the controller, the controller to cause the printing device to print data on the print medium prior to processing the print medium with the page processing mechanism.

10. The system of claim 8, the controller to:
determine a second attribute of a subsequent print medium;
adjust the print processing parameter based on the second attribute; and
cause the subsequent print medium to be processed, based on the print processing parameter that is based on the second attribute, by the page processing mechanism.

11. The system of claim 8, wherein the print processing mechanism includes a heater or a fan.

12. The system of claim 8, the controller to:
cause the print medium to be processed by the page processing mechanism for a first amount of time; and
cause a subsequent print medium to be processed with the page processing mechanism for a second amount of time.

13. The system of claim 8, wherein the attribute includes an amount of moisture on the print medium.

14. A method, comprising:
determining a first attribute of a first print medium;
adjusting a first print processing parameter based on the first attribute;
processing, with a page processing mechanism, the first print medium based, at least in part, on the first print processing parameter;
determining a second attribute of a second print medium;
adjusting a second print processing parameter, based on the second attribute; and
processing, with the page processing mechanism, the second print medium based, at least in part, on the second print processing parameter.

15. The method of claim 14, further comprising:
adjusting a first speed at which the first print medium is processed; and
adjusting a second speed at which the second print medium is processed, wherein the first speed and the second speed are based, at least in part on determining the first attribute and the second attribute.
